(19) United States
(12) Patent Application Publication
(10) Pub. No.: US 2009/0057453 A1
(43) Pub. Date: Mar. 5, 2009

(54) Self Sharpening Grinder Tooth

(76) Inventor: Curtis Ellison, Hubbard, TX (US)

Correspondence Address: ANDERSON, LEVINE & LINTEL L.L.P., 14785 PRESTON ROAD, SUITE 650, DALLAS, TX, 75254, US

(21) Appl. No.: 12/198,785

(22) Filed: Aug. 26, 2008

Related U.S. Application Data
(60) Provisional application No. 60/968,197, filed on Aug. 27, 2007.

(51) Int. Cl. B02C 13/00; B21K 23/00

(52) U.S. Cl. 241/195; 83/835; 76/101.1

(57) ABSTRACT

A tooth is provided for use in a wood grinding device comprising a base and a tip formed on the base. The tip is formed from an alloy including steel and tungsten carbide. The tip could have a cross shape, a helical cross shape, or a triangular profile.

### CROSS-REFERENCE TO RELATED APPLICATIONS

This application claims the benefit of the filing date of copending provisional application U.S. Ser. No. 60/968,197, filed Aug. 27, 2007, entitled “Self Sharpening Grinder Tooth”, which is incorporated by reference herein.

### STATEMENT OF FEDERALLY SPONSORED RESEARCH OR DEVELOPMENT

Not Applicable

### BACKGROUND OF THE INVENTION

1. Technical Field

This invention relates in general to land clearing devices and, more particularly, to a self sharpening tooth for use in a land clearing device.

2. Description of the Related Art

Land clearing devices are used in a number of applications, including right of way clearing, fire containment and other general clearing applications. A number of companies make land-clearing devices, including TUSHOGG of Lufkin, Tex. and MAGNUM Systems of Tampa, Fla. A key objective of the land clearing device is its ability to grind tree stumps and other wood refuse into fine mulch.

A land clearing device may be a stand-alone device incorporating is own transport, or an attachment that is coupled to a tractor. The land clearing device uses a rotating cylinder (rotor) which has a plurality of teeth attached to the cylinder, as shown in FIGS. 1a and 1b. As the rotor 10 rotates, the teeth 12 impact the wood or other organic matter to grind it into a fine mulch. A typical land clearing device may have from 50 to 75 teeth. The TUSHOGG device uses rotating teeth while the MAGNUM system uses stationary teeth.

A front view of a tooth 12 made by TUSHOGG is shown in FIG. 2. The TUSHOGG tooth 13 is generally cylindrical in shape with an extremely hard carbide tipped point 14. As it rotates with the rotor 10, the tooth 13 can also rotate in an orthogonal plane.

The problems with the TUSHOGG tooth 13 are two-fold. First, the hard carbide tip 14 is subject to breakage. Second, the point 14 does a poor job in creating a fine mulch, as it tends to split the wood into large chunks. In many cases, the fineness of the mulch is specified, so the land clearing device must make multiple passes over the shredded wood to meet specifications.

Side and front views of the MAGNUM tooth 16 is shown in FIGS. 3a and 3b, respectively. Each tooth (or “hammer”) 16 has two carbide tips 18, which impact and shred wood. While the MAGNUM tooth 16 does an adequate job of creating a fine mulch, its tips 18 are subject to premature breakage. Further, welding the tips 18 to the body of the tooth 16 can be a complicated and expensive process.

When a tooth breaks, it can throw the machine out of balance, making the machine difficult and/or dangerous to operate.

Accordingly, a need has arisen for a long-life land clearing tooth which creates fine mulch.

### BRIEF SUMMARY OF THE INVENTION

In the present invention, a tooth is provided for use in a wood grinding device comprising a base and a tip formed on the base. The tip comprises two or more extensions formed from an alloy including steel and tungsten carbide. The tip could have a cross shape, a helical cross shape, or use multiple tips with triangular profiles, for example.

The present invention provides significant advantages over the prior art. The softer alloy of steel and tungsten carbide provides a tip that is self-sharpening and less likely to break during use. Further, the tips may be formed directly on top of a base, rather than formed separately and attached using an expensive welding process.

### BRIEF DESCRIPTION OF THE SEVERAL VIEWS OF THE DRAWINGS

For a more complete understanding of the present invention, and the advantages thereof, reference is now made to the following descriptions taken in conjunction with the accompanying drawings, in which:

FIGS. 1a-b illustrates a prior art land clearing device;

FIG. 2 illustrates a pointed tooth for use in the land clearing device of FIGS. 1a-b;

FIGS. 3a-b illustrate a dual-tipped tooth for use in the land clearing device of FIGS. 1a-1b;

FIGS. 4a through 4b illustrate a top view and a side view, respectively, of a first embodiment of a tooth that can be used as a replacement for the tooth shown in FIG. 2;

FIGS. 5a through 5b illustrate a top view and a side view, respectively, of a second embodiment of a tooth that can be used as a replacement for the tooth shown in FIG. 2;

FIGS. 6a through 6e illustrate the fabrication of the tip of the tooth of FIGS. 4a-b or 5a-b;

FIG. 7 illustrates an embodiment of a tooth that can be used as a replacement for the tooth shown in FIGS. 3a-b;

FIGS. 8a and 8b illustrate another embodiment of a tooth.

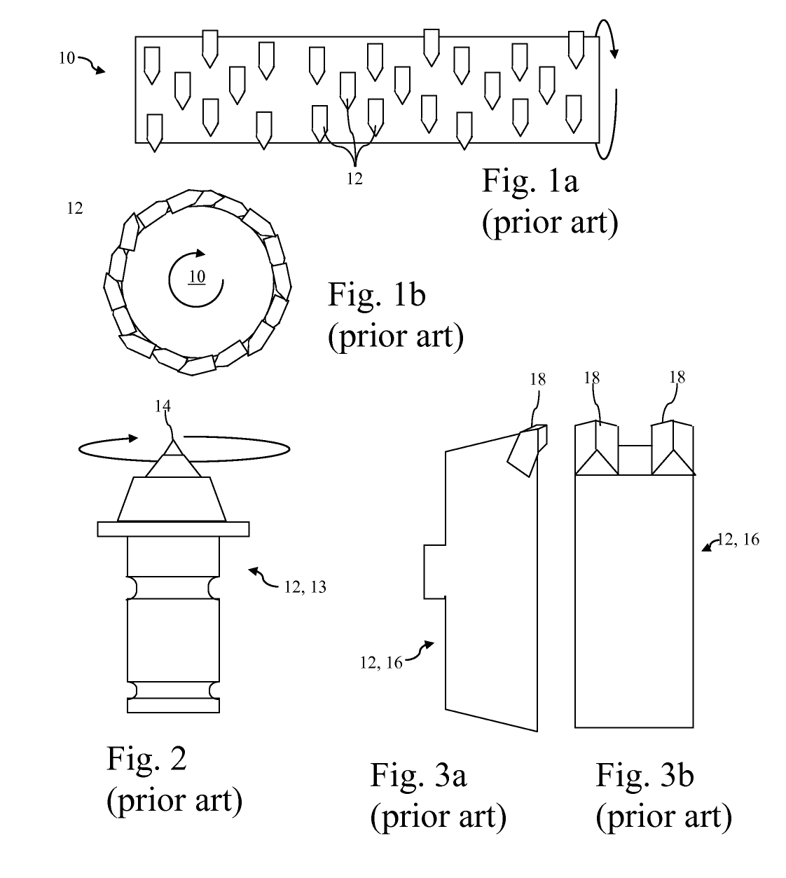

### DETAILED DESCRIPTION OF THE INVENTION

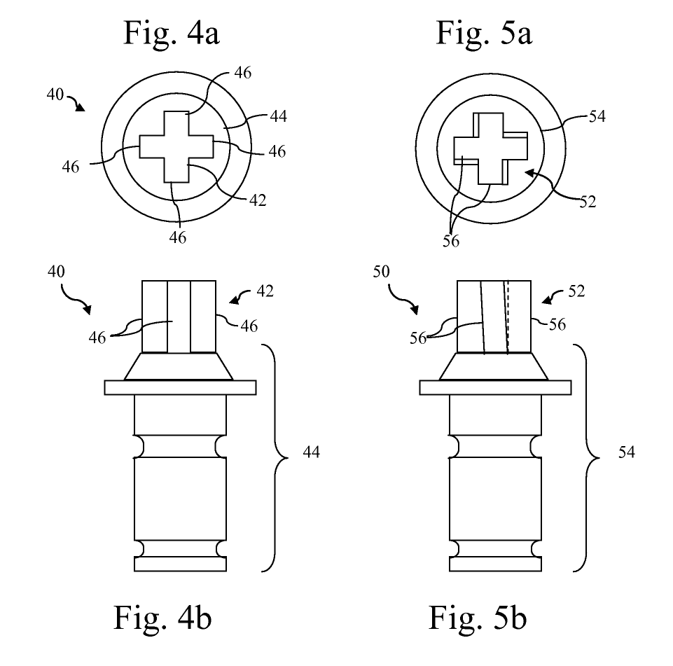

The present invention is best understood in relation to FIGS. 4-8 of the drawings, like numerals being used for like elements of the various drawings.

FIGS. 4a through 4b illustrate a first embodiment of a tooth that can be used as a replacement for the single-pointed tooth 13 shown in FIG. 2.

Instead of using a single-point tip, such as tip 14, tooth 40 incorporates a cross shaped tip 42 on top of a tooth body 44. The tooth body 44. can be made of steel, or any other suitable material. The tooth tip 44 is made of an alloy of metals, described below. The tip 42 includes four extensions 46.

FIG. 5a through 5b illustrate a second embodiment of a tooth that can be used as a replacement for the single-pointed tooth 13 shown in FIG. 2. Tooth 50 is substantially the same as tooth 40, with the exception that the cross-shaped tip 52 is formed on body 54 such that each extension 56 of the tip is formed on a bias, creating a slight tilt from the vertical (shown in phantom), such that the extensions of tip 52 are slightly helical.

In operation, the teeth 40 and 50 rotate during drilling, as described in connection with the tooth of FIG. 2. However, due to the cross-shaped tip 44 or 54, wood is shredded into a much finer mulch, as compared to the tip 14 of FIG. 2, requiring only a single pass to meet typical requirements under normal conditions.

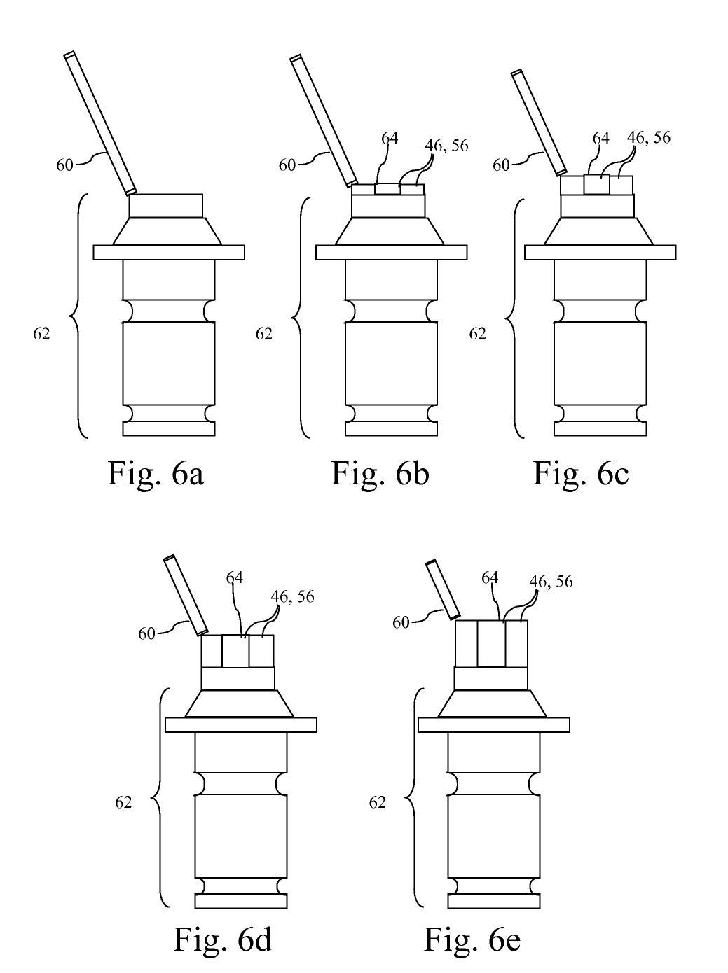

In addition, the tips 44 and 54 are, in the preferred embodiment, not formed of a hard carbide, as used in tips of prior art teeth. Instead, the tips are formed of an alloy which is soft enough to wear slightly during use such that the tip becomes self sharpening. Further, the softer tip is less prone to breakage. A process for forming the tips is shown in FIGS. 6a-e.

To prepare the alloy a hollow steel tube is crimped at one end and a stick of RG60 high test steel is placed in the tube. Crushed tungsten carbide is the poured into the tube and packed around the stick of RG60. The other end of the stick is then crimped. The combination of these three metals is then used to form the tip as shown in FIGS. 6a-e.

Two formulations which have been shown to be proper for the application of mulching tree stumps is given below:

Formulation 1:

Tube steel (approximately 18″ long; wall thickness 0.042″): 2.2 oz (53.66% of total weight)

RG60 Hitest 3/32″ (diameter) rod: 0.6 oz (14.63% of total weight)

Tungsten Carbide 60/100: 1.3 oz (31.71% of total weight)

Formulation 2:

Tube steel (approximately 18.25″ long; wall thickness 0.028″): 2.1 oz (46.67% of total weight)

RG60 Hitest ⅛″ (diameter) rod: 0.8 oz (17.78% of total weight)

Tungsten Carbide 40/80 crystalline: 1.6 oz (35.55% of total weight)

RG60 is a high strength carbon steel welding rod. A typical wire chemistry for RG60 is C (0.11), Si (0.15) and Mn (1.10).

In general, the higher the percentage of tungsten carbide, the harder the alloy will be. If the allow is too soft, the point will deform into a flat surface, rather than self sharpen. If the point is too hard, it will break easily.

The stick 60, prepared as described above, is used to form the tip on a base 62. In FIGS. 6a-e, the base is shown in a configuration used for a rotating tooth; however, other base configurations could be used as desired.

The stick 60 is heated with a torch along with the top of base 62. The stick is heated to a temperature at which the constituent metals in the stick 60 begin to melt together to form a molten alloy at the bottom of the stick 60. The top of the base 60 is heated to a point where the base will bond with the molten alloy. As the metal at the bottom of the stick 60 becomes molten, the stick is moved along the top of the base 62 to create a layer of the alloy in the shape of the tip 64, as shown in FIG. 6b. Additional layers are provided on top of the first layer, building the tip layer by layer, as shown in FIGS. 6c-e. Thus, as layers are added, the tip 64 increases in height. While the above process is described in terms of manual fabrication, the same alloy could be used to create the tip using automated processes.

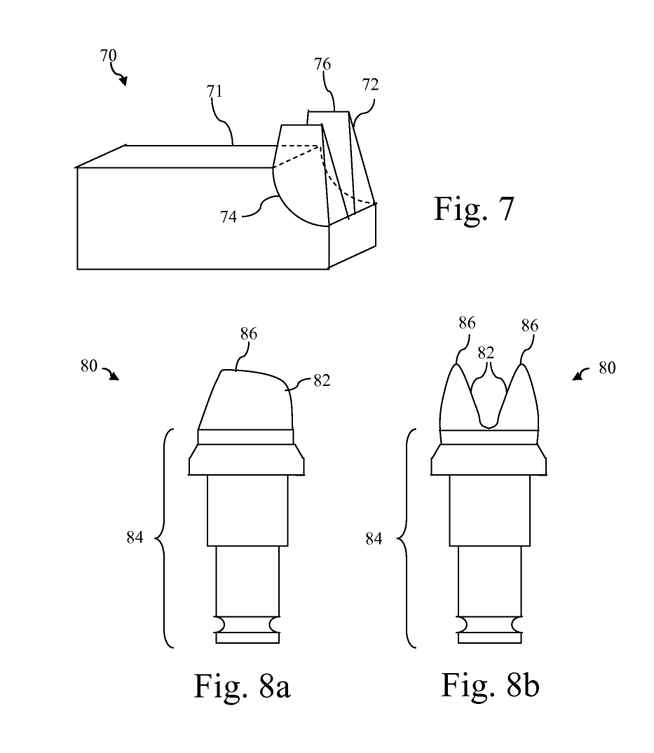

FIG. 7 illustrates an embodiment of a stationary tooth 70 that can be used as a replacement for the tooth shown in FIGS. 3a-b. In this embodiment, a base 71 has two tips 72 formed thereon, using the process shown in FIGS. 6a-e. In the preferred embodiment, the base 71 has a curved support 74 upon which the extensions 72 are formed. As before, the tips 72 are formed layer by layer until a proper shape and size is achieved. Each tip 72 has a triangular profile with the exposed pointed edge 76 of the triangle pointing outwardly from a side of the base 71.

The present invention provides significant advantages over the prior art. First, a new shape is provided for finer mulching capabilities. Second, a tip is provided which is self-sharpening. Third, the tip is much less likely to break during use, because of the softness of the alloy. Fourth, the tips may be formed directly on top of a base, rather than formed separately and attached using an expensive welding process.

FIGS. 8a and 8b illustrate another design for a tooth 80 which is compatible with the Tushogg cutting head, but produces a finer mulch. Like the tooth 70 of FIG. 7, tooth 80 has two elongate tips 82 formed on a base 84, with each tip having a substantially triangular profile as shown in FIG. 8b; however, in this embodiment, as opposed to tooth 70, each tip 82 has an exposed pointed edge 86 which points substantially outwardly from the top of the base 84, rather than outwardly from the side. The tips are formed using the process described above.

In addition to providing a finer mulch, the tooth 80 is self sharpening as the mulch is being made. Also the tip is more resistant to breakage, due to the softness of the alloy. Additionally, the tips are less expensive to produce because they do not require an expensive welding process.

Although the Detailed Description of the invention has been directed to certain exemplary embodiments, various modifications of these embodiments, as well as alternative embodiments, will be suggested to those skilled in the art. The invention encompasses any modifications or alternative embodiments that fall within the scope of the Claims.

What is claimed is:

1. A tooth for use in a wood grinding device, comprising:
a base;
a tip formed on the base using an alloy including steel and tungsten carbide.

2. The tooth of claim 1 wherein the tip is in the shape of a cross.

3. The tooth of claim 2 wherein the cross is helical.

4. The tooth of claim 1 wherein the tip has a triangular profile.

5. The tooth of claim 4 wherein the base has a side portion and a top portion and the tip has an exposed pointed edge which points substantially outwardly from the side of the base.

6. The tooth of claim 4 wherein the base has a side portion and a top portion and the tip has an exposed pointed edge which points substantially outwardly from the top of the base.

7. A wood grinding device comprising:
a rotating drum;
a plurality of teeth attached to the drum, each tooth comprising:
a base;
a tip formed on the base using an alloy including steel and tungsten carbide.

8. The tooth of claim 7 wherein the tip is in the shape of a cross.

9. The tooth of claim 8 wherein the cross is helical.

10. The tooth of claim 7 wherein the tip has a triangular profile.

11. The tooth of claim 10 wherein the base has a side portion and a top portion and the tip has an exposed pointed edge which points substantially outwardly from the side of the base.

12. The tooth of claim 10 wherein the base has a side portion and a top portion and the tip has an exposed pointed edge which points substantially outwardly from the top of the base.

13. A method of forming a tooth for use in a wood grinding device, comprising the steps of:
combining steel and tungsten carbide in a tube;
heating the tube to melt the tube and its contents into a molten alloy;
forming layers of the molten alloy onto a base.

14. The method of claim 13 wherein the tube is made of steel.

15. The method of claim 13 wherein the combining step comprises the step of combining a steel rod and crushed tungsten steel in the tube.
